(19) United States
(12) Patent Application Publication
(10) Pub. No.: US 2024/0144326 A1
(43) Pub. Date: May 2, 2024

(54) METHODS AND SYSTEMS FOR ESTIMATING THE STATUS OF A VEHICLE USING INTERACTION DATA

(71) Applicant: Capital One Services, LLC, McLean, VA (US)

(72) Inventors: Viraj CHAUDHARY, Katy, TX (US); Abhay DONTHI, Cary, NC (US); Cruz VARGAS, Ocean Springs, MS (US)

(73) Assignee: Capital One Services, LLC, McLean, VA (US)

(21) Appl. No.: 18/051,390

(22) Filed: Oct. 31, 2022

(51) Int. Cl. G06Q 30/02

(52) U.S. Cl. CPC G06Q 30/0278

(57) ABSTRACT

Methods and systems for estimating a vehicle status using interaction data are disclosed. An exemplary method can include obtaining, via at least one processor, information associated with a vehicle; obtaining, via the at least one processor, a set of interaction data of an individual associated with the vehicle; and accessing, via the at least one processor and on a memory, a framework indicative of an association between interaction data and vehicles status. An exemplary method may further include generating, via the at least one processor and by applying the framework to the set of interaction data and the information associated with the vehicle, an estimate of the vehicle status; generating, via the at least one processor and based on the estimate of the vehicle status, at least one evaluation for the vehicle; and outputting the at least one evaluation.

### TECHNICAL FIELD

Various embodiments of the present disclosure relate generally to methods and systems for estimating a vehicle status and, more particularly, to methods and systems for generating an evaluation of a vehicle using interaction data.

### BACKGROUND

At some point, many vehicle owners will sell, trade-in, and/or refinance their vehicle. In these instances, the condition and value of the vehicle may be especially relevant, but many aspects of the status of a vehicle may be difficult to evaluate. For example, while some indicators of the status of a vehicle may be capable of being observed during a visual inspection, some aspects of the vehicle status may be difficult to ascertain, even with a visual inspection. For instance, whether or not the vehicle has had its regular maintenance performed may not be discernible without a comprehensive inspection including an engine tear down, if at all. Further, even a visual inspection may not be possible or practical in many circumstances, for example, a remote sale or refinancing from a lender without a local presence. This lack of knowledge of the status of the vehicle may adversely impact a vehicle's valuation, and may result in a reduced sale or trade-in price, less favorable financing terms, and/or a subsequent vehicle owner facing unexpected repair costs.

The present disclosure is directed to addressing one or more of these above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

According to certain aspects of the disclosure methods and systems are disclosed for estimating a vehicle status using interaction data. Each of the examples disclosed herein may include one or more of the features described in connection with any of the other disclosed examples.

In one aspect, an exemplary embodiment of a computer-implemented method for estimating a vehicle status using interaction data may include: obtaining, via at least one processor, information associated with a vehicle; obtaining, via the at least one processor, a set of interaction data of an individual associated with the vehicle; and accessing, via the at least one processor and on a memory, a framework indicative of an association between interaction data and vehicles status. An exemplary method may further include generating, via the at least one processor and by applying the framework to the set of interaction data and the information associated with the vehicle, an estimate of the vehicle status; generating, via the at least one processor and based on the estimate of the vehicle status, at least one evaluation for the vehicle; and outputting the at least one evaluation.

An exemplary embodiment of a system may include a memory storing instructions and a processor executing the instructions to perform a process for estimating a vehicle status using interaction data. The process may include obtaining, via at least one processor, information associated with a vehicle; obtaining, via the at least one processor, a set of interaction data of an individual associated with the vehicle; and accessing, via the at least one processor and on a memory, a framework indicative of an association between interaction data and vehicles status. The process may further include generating, via the at least one processor and by applying the framework to the set of interaction data and the information associated with the vehicle, an estimate of the vehicle status; generating, via the at least one processor and based on the estimate of the vehicle status, at least one evaluation for the vehicle; and outputting the at least one evaluation.

A method for estimating a vehicle status using interaction data can include: obtaining, via at least one processor, information associated with a vehicle; obtaining, via the at least one processor, a set of interaction data of an individual associated with the vehicle; and accessing, via the at least one processor and on a memory, a framework indicative of an association between interaction data and vehicles status. The method may further include applying the framework to the set of interaction data and the information associated with the vehicle, including identifying, via the at least one processor, a subset of interaction data from amongst the set of interaction data that are likely indicative of the vehicle status; generating, via the at least one processor and based on the subset of interaction data, an estimate of the vehicle status including at least an estimation of a condition of the vehicle; generating, via the at least one processor and based on the estimate of the vehicle status, at least one evaluation for the vehicle; and outputting the at least one evaluation.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment that may be utilized, according to one or more embodiments of the present disclosure.

FIG. 2 depicts an exemplary process for generating and outputting an evaluation of a vehicle, according to one or more embodiments of the present disclosure.

FIG. 3 depicts an example of a computing device, according to one or more embodiments of the present disclosure.

### DETAILED DESCRIPTION OF EMBODIMENTS

The terminology used in this disclosure is to be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “computer system” generally encompasses any device or combination of devices, each device having at least one processor that executes instructions from a memory medium. Additionally, a computer system may be included as a part of another computer system.

In this disclosure, the term “based on” means “based at least in part on.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially,” “approximately,” “about,” and “generally,” are used to indicate a possible variation of ±10% of a stated or understood value.

In general, the present disclosure provides methods and systems for estimating a vehicle status using interaction data. The methods and systems disclosed may enable an institution to identify interactions indicative of vehicle maintenance based on an analysis of interaction records and other information available to the institution. It is often the case that a person's interaction patterns include at least some interactions that are relevant to determining the degree of care the person is taking of the vehicle. For example, a person may have interactions with a vehicle maintenance provider or merchant that sells vehicle maintenance items. A person's interaction records may also include interactions indicative of the type and amount of vehicle use, such as fuel transactions that occur at particular locations that could allow an institution to estimate a proportion of the vehicle use that is city and/or highway use. As a result, an institution that is able to identify and analyze relevant interactions may be able to improve an estimate of a vehicle status beyond that which is determined based only on visually apparent information (e.g., exterior condition, vehicle mileage).

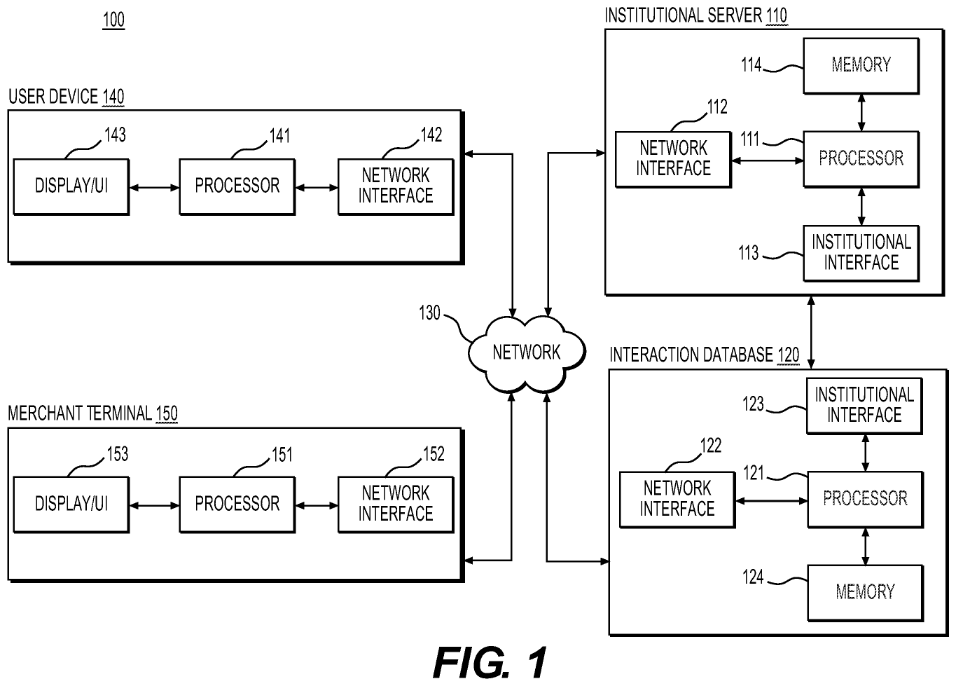

FIG. 1 depicts an exemplary system environment 100 that may be utilized with techniques presented herein. For example, the environment 100 may include institutional server 110 which may obtain and analyze interaction records. Institutional server 110 may include a processor 111 to execute instructions, and a network interface 112 with which to communicate with other elements in system environment 100. In some embodiments, institutional server 110 may also include an institutional interface 113, in addition to or in combination with network interface 112, which may enable institutional server 110 to communicate with a secure interaction database 120. Instructions to be executed by processor 111 may be stored in memory 114.

Interaction database 120 may be, for example, a secure server or other system associated with an institution and on which interaction data may be stored. Interaction database 120 may include a processor 121 that may execute instructions stored in a memory 124 in order to allow interaction database 120 to receive and store interaction data received via a network interface 122 and/or an institutional interface 123.

Network interface 112 of institutional server 110 and network interface 122 of interaction database 120 may communicate with each other and/or other elements of the system environment 100 via network 130. Network 130 may be implemented as, for example, the Internet, a wireless network, a wired network (e.g., Ethernet), a local area network (LAN), a Wide Area Network (WANs), Bluetooth, Near Field Communication (NFC), or any other type of network or combination of networks that provides communications between one or more components of the system environment 100. In some embodiments, the network 130 may be implemented using a suitable communication protocol or combination of protocols such as a wired or wireless Internet connection in combination with a cellular data network.

Network 130 may provide institutional server 110 and institutional database 120 with access to data associated with user interactions such as those conducted via and/or stored on a user device 140, and/or a merchant terminal 150. User device 140 can be, for example, a computer, smartphone, tablet, or other network-accessible computing device, and may include a processor 141, a network interface 142, and a display/UI 143. User device 140 may be capable of allowing a user to conduct interactions, and it may further allow the user to receive information from institutions. Processor 141 may execute instructions to perform functions including, for example, transacting with merchant terminal 150, providing data regarding those or other interactions to institutional server 110 and/or interaction database 120, and/or presenting a user with information received from institutional server 110.

Merchant terminal 150 may carry out interactions such as commercial transactions by using processor 151, and can in turn provide data regarding those interactions, via network 130 and network interface 152, to institutional server 110 and/or interaction database 120. While system environment 100, as illustrated in FIG. 1, is depicted as having a single user device 140 and merchant terminal 150, this disclosure contemplates that there may be more than one of one or more of these (or other) elements without departing from the scope of the disclosure. For example, the user may conduct (or store) interactions with multiple user devices 140 and/or multiple merchant terminals 150.

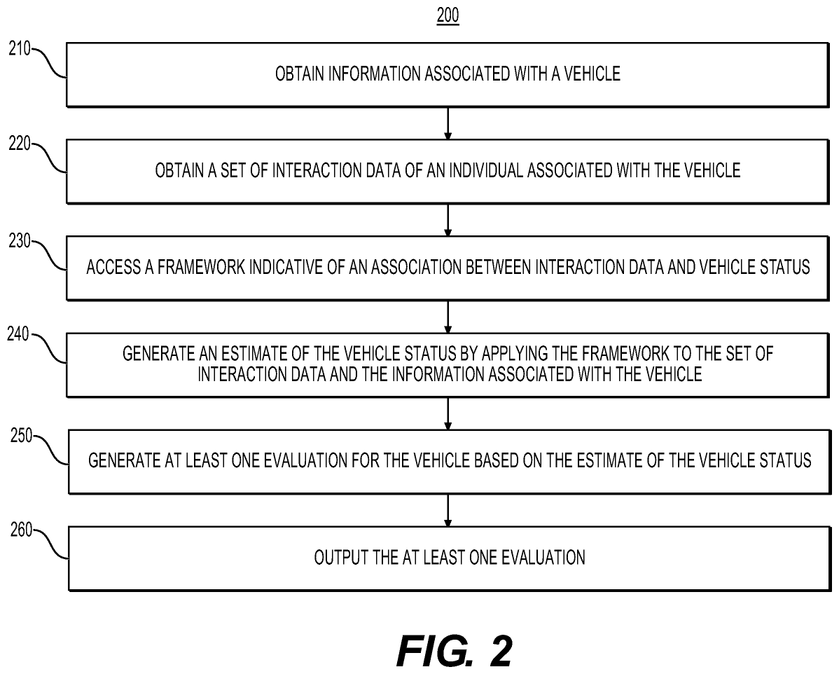

FIG. 2 illustrates a method 200 for generating and outputting an evaluation for a vehicle, according to some embodiments of the present disclosure. The method may be performed by a system in accordance with the present disclosure, including one or more of the devices that comprise the system environment 100. For example, in some embodiments in accordance with the present disclosure, method 200 may be carried out by institutional server 110. Institutional server 110 may be, for example, associated with an institution such as a bank, vehicle financer, vehicle marketplace, insurance company, or other institution that could benefit from improved vehicle status estimates.

Method 200 may begin at step 210 by obtaining information associated with a vehicle. This information may be retrieved from institutional server 110, interaction database 120, and/or user device 140. Vehicle information may include, for example, a location, identity, age, accident history, or value of the vehicle. These categories of information can include a vehicle identification number (VIN), year/make/model/trim level, options or other vehicle features, a price paid for the vehicle, and/or images of the vehicle. In some embodiments, the information obtained may include an initial estimate of the value or condition of the vehicle based on conventionally available information which may then be refined and improved as the method proceeds.

Method 200 may continue, at step 220, to obtain a set of interaction data of an individual associated with the vehicle. The set of interaction records may be obtained, via network 130 (and/or institutional interfaces 113, 123), from one or more of institutional database 120, user device 140, and merchant terminal 150. The set of interaction records may include information such as, for example, the identity of parties involved, an amount being transacted, and nature of interaction. In some embodiments, the individual associated with the vehicle may have the option of providing additional interaction records, such as receipts from vehicle services or maintenance that may not be available from the resources noted above, via a direct portal, website, or mobile application.

Once the information associated with a vehicle and the set of interaction data have been obtained, method 200 may continue at step 230 by accessing a framework indicative of an association between interaction data and vehicle status. This framework can include various methods of identifying relevant interactions and correlating those interactions with a change or verification of the status or condition of the vehicle. In some applications, this framework can include a machine learning model that has been trained on available data relating to the correlation between certain interaction types and vehicle status. For example, the framework may determine a particular value to add to the vehicle status estimation based on interactions such as regular oil changes or the performance of scheduled/preventative maintenance. The framework may also leverage interaction data related to, for example, fuel expenses, to estimate a proportion of vehicle use at lower wear, higher fuel efficiency use (e.g., highway driving) as compared to higher wear, lower fuel efficiency use (e.g., city driving).

The framework may then be applied to the set of interaction data and the information associated with the vehicle, and, at step 240, an estimate of the vehicle status can be generated. For example, this estimate may take the form of a relative value and/or grade, and may include a number of components or subcategories such as engine condition, exterior condition, interior condition, or the like. The estimate may include a range or confidence interval as well, which may be based upon the amount and strength of the interaction data and/or information associated with the vehicle to which the framework was applied.

In some embodiments, the framework itself may identify a subset of interaction data from amongst the set of interaction data that are likely related to and/or indicative of the vehicle status. The application of the framework to the set of interaction data can include determining one or more merchant categories, such as maintenance and/or fuel providers, likely relevant to the subset of interaction data from amongst the set of interaction data that are likely indicative of the vehicle status. Interactions in these merchant categories, such as those identified as vehicle maintenance interactions, may then be given more or less weight in the status estimate based on an amount, frequency, and/or timing of the subset of interactions. In such embodiments, the estimate of the vehicle status may be based on this subset of the obtained interaction data.

At step 250, at least one evaluation for the vehicle can be generated based on the estimate of the vehicle status. The evaluation may be done by any suitable method, including the use of additional machine learning techniques/models, and the goal of the evaluation can be to provide a more accurate assessment of the vehicle's condition and/or market value based on the analysis of the set of interaction records. In some embodiments, an appropriate vehicle evaluation could also be used to predict future conditions or market values based on patterns related to the individual associated with the vehicle, the vehicle, or both.

As used herein, a “machine learning model” is a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used (e.g., stochastic, gradient boosted, random seeded, recursive, epoch or batch-based). Training data sets may be used, and such sets may contain, for example, available institutional data related to users that have had their interactions analyzed and their vehicles thoroughly evaluated and/or monitored.

Once at least one evaluation has been generated, at step 260, one or more of the evaluations may be outputted for further use, such as being presented to an institution, the individual associated with the vehicle, an entity from which the set of interaction data was obtained, and/or a prospective purchaser of the vehicle. The evaluation may provide a user and/or institution with a market value for the vehicle that is specific to the vehicle and the individual associated with the vehicle in a manner not practical when the evaluation is based solely on the year/make/model and mileage of the vehicle. As such, an institution may be able to, for example, provide a better refinancing rate, offer a higher trade-in value for the vehicle, and/or provide more timely suggestions or offers for refinancing or trading in a vehicle.

In some embodiments, the evaluations may be generated and used to recommend actions that could be taken with respect to the vehicle. For example, the evaluation may cause a recommendation to be transmitted to the individual to indicate that may be an opportune time to buy, sell, refinance, or otherwise act with regard to the vehicle.

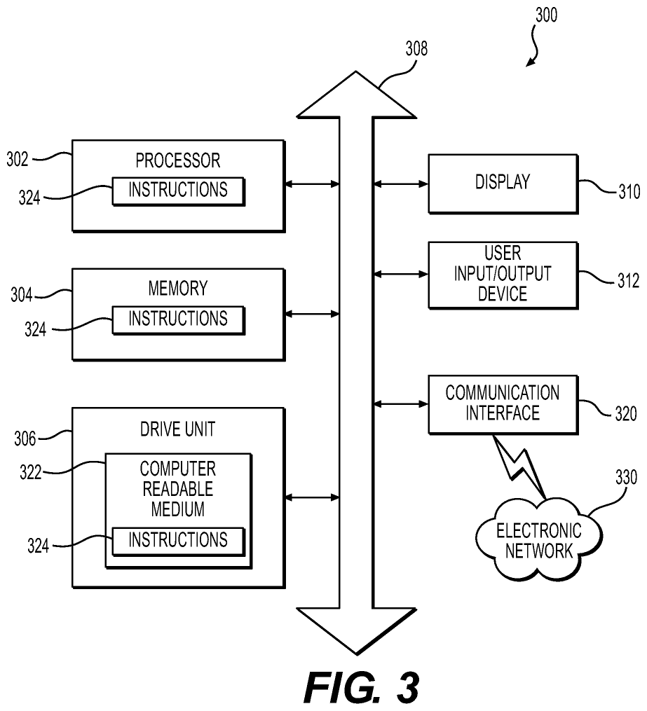

FIG. 3 is a simplified functional block diagram of computer system 300 that may be configured as a device for executing the disclosed methods, for example, the method of FIG. 2, according to exemplary embodiments of the present disclosure. FIG. 3 is a simplified functional block diagram of a computer system that may generate interfaces and/or another system according to exemplary embodiments of the present disclosure. In various embodiments, any of the systems (e.g., computer system 300) herein may be an assembly of hardware including, for example, data communication interface 320 for packet data communication. Computer system 300 also may include central processing unit (“CPU”) 302, in the form of one or more processors, for executing program instructions. The computer system 300 may include an internal communication bus 308, and storage drive unit 306 (such as ROM, HDD, SDD, etc.) that may store data on computer readable medium 322, although the computer system 300 may receive programming and data via network communications. Computer system 300 may also have memory 304 (such as RAM) storing instructions 324 for executing techniques presented herein, although the instructions 324 may be stored temporarily or permanently within other modules of computer system 300 (e.g., processor 302 and/or computer readable medium 322). Computer system 300 also may include input and output ports 312 and/or display 310 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In one embodiment, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming.

All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the presently disclosed methods, devices, and systems are described with exemplary reference to transmitting data, it should be appreciated that the presently disclosed embodiments may be applicable to any environment, such as a desktop or laptop computer. Also, the presently disclosed embodiments may be applicable to any type of Internet protocol. It is intended that the specification and examples be considered as exemplary only, with a true scope and spirit of the disclosure being indicated by the following claims.

In general, any process discussed in this disclosure that is understood to be performable by a computer may be performed by one or more processors. Such processes include, but are not limited to, the process shown in FIG. 2, and the associated language of the specification. The one or more processors may be configured to perform such processes by having access to instructions (computer-readable code) that, when executed by the one or more processors, cause the one or more processors to perform the processes. The one or more processors may be part of a computer system (e.g., one of the computer systems discussed above) that further includes a memory storing the instructions. The instructions also may be stored on a non-transitory computer-readable medium. The non-transitory computer-readable medium may be separate from any processor. Examples of non-transitory computer-readable media include solid-state memories, optical media, and magnetic media.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above-disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for estimating a vehicle status using interaction data, comprising:
obtaining, via at least one processor, information associated with a vehicle;
obtaining, via the at least one processor, a set of interaction data of an individual associated with the vehicle;
accessing, via the at least one processor and on a memory, a framework indicative of an association between interaction data and vehicle status;
generating, via the at least one processor and by applying the framework to the set of interaction data and the information associated with the vehicle, an estimate of the vehicle status;
generating, via the at least one processor and based on the estimate of the vehicle status, at least one evaluation for the vehicle; and
outputting the at least one evaluation.

2. The computer-implemented method of claim 1, wherein the information associated with the vehicle includes one or more of a location, identity, age, or value of the vehicle.

3. The computer-implemented method of claim 1, wherein the estimate of the vehicle status includes an estimation of a condition of the vehicle.

4. The computer-implemented method of claim 1, wherein:
applying the framework to the set of interaction data includes identifying, via the at least one processor, a subset of interaction data from amongst the set of interaction data that are likely indicative of the vehicle status; and
generating of the estimate of the vehicle status is based on the subset of interaction data.

5. The computer-implemented method of claim 4, wherein applying the framework to the set of interaction data includes determining one or more merchant categories likely relevant to the subset of interaction data from amongst the set of interaction data that are likely indicative of the vehicle status.

6. The computer-implemented method of claim 5, wherein identifying the subset of interaction data includes identifying interactions within the set of interaction data that involve merchants within the one or more merchant categories.

7. The computer-implemented method of claim 4, wherein the subset of interaction data from amongst the set of interaction data that are likely indicative of the vehicle status include interactions related to vehicle maintenance.

8. The computer-implemented method of claim 1, wherein generating the at least one evaluation of the vehicle includes modifying the estimate of the vehicle status.

9. The computer-implemented method of claim 8, further comprising providing the at least one evaluation of the vehicle to at least one of the individual associated with the vehicle, an entity from which the set of interaction data was obtained, or a prospective purchaser of the vehicle.

10. A system for estimating a vehicle status using interaction data, the system comprising:
a memory storing instructions; and
a processor executing the instructions to perform a process including:
obtaining, via at least one processor, information associated with a vehicle;
obtaining, via the at least one processor, a set of interaction data of an individual associated with the vehicle;
accessing, via the at least one processor and on a memory, a framework indicative of an association between interaction data and vehicles status;
generating, via the at least one processor and by applying the framework to the set of interaction data and the information associated with the vehicle, an estimate of the vehicle status;
generating, via the at least one processor and based on the estimate of the vehicle status, at least one evaluation for the vehicle; and
outputting the at least one evaluation.

11. The system of claim 10, wherein the information associated with the vehicle includes one or more of a location, identity, age, or value of the vehicle.

12. The system of claim 10, wherein the estimate of the vehicle status includes an estimation of a condition of the vehicle.

13. The system of claim 10, wherein:
applying the framework to the set of interaction data includes identifying, via the at least one processor, a subset of interaction data from amongst the set of interaction data that are likely indicative of the vehicle status; and
generating of the estimate of the vehicle status is based on the subset of interaction data.

14. The system of claim 13, wherein applying the framework to the set of interaction data includes determining one or more merchant categories likely relevant to the subset of interaction data from amongst the set of interaction data that are likely indicative of the vehicle status.

15. The system of claim 14, wherein identifying the subset of interaction data includes identifying interactions within the set of interaction data that involve merchants within the one or more merchant categories.

16. The system of claim 13, wherein the subset of interaction data from amongst the set of interaction data that are likely indicative of the vehicle status include interactions related to vehicle maintenance.

17. The system of claim 10, wherein generating the at least one evaluation of the vehicle includes modifying the estimate of the vehicle status.

18. The system of claim 17, further comprising providing the at least one evaluation of the vehicle to at least one of the individual associated with the vehicle, an entity from which the set of interaction data was obtained, or a prospective purchaser of the vehicle.

19. A method for estimating a vehicle status using interaction data, comprising:
obtaining, via at least one processor, information associated with a vehicle;
obtaining, via the at least one processor, a set of interaction data of an individual associated with the vehicle;
accessing, via the at least one processor and on a memory, a framework indicative of an association between interaction data and vehicles status;
applying the framework to the set of interaction data and the information associated with the vehicle, including identifying, via the at least one processor, a subset of interaction data from amongst the set of interaction data that are likely indicative of the vehicle status;
generating, via the at least one processor and based on the subset of interaction data, an estimate of the vehicle status including at least an estimation of a condition of the vehicle;
generating, via the at least one processor and based on the estimate of the vehicle status, at least one evaluation for the vehicle; and
outputting the at least one evaluation.

20. The method of claim 19, wherein applying the framework to the set of interaction data includes determining one or more merchant categories likely relevant to the subset of interaction data from amongst the set of interaction data that are likely indicative of the vehicle status.
